(19) United States
(12) Patent Application Publication
(10) Pub. No.: US 2023/0069036 A1
(43) Pub. Date: Mar. 2, 2023

(54) CAMERA MODULE

(71) Applicant: SAMSUNG ELECTRO-MECHANICS CO., LTD., Suwon-si (KR)

(72) Inventors: In Gun KIM, Suwon-si (KR); Kyung Ho BAEK, Suwon-si (KR)

(73) Assignee: SAMSUNG ELECTRO-MECHANICS CO., LTD., Suwon-si (KR)

(21) Appl. No.: 17/564,395

(22) Filed: Dec. 29, 2021

(30) Foreign Application Priority Data
Aug. 30, 2021 (KR) 10-2021-0114943

(51) Int. Cl. G02B 7/02; H04N 5/225

(52) U.S. Cl. CPC G02B 7/026; H04N 5/2254; G02B 7/04

(57) ABSTRACT

A lens module includes a lens barrel; a lens accommodated in the lens barrel; and a coupling member coupled to the lens barrel, disposed on one side of the lens to fix the lens to the lens barrel. A width of the lens in a first direction perpendicular to an optical axis is smaller than a width of the lens in a second direction perpendicular to the optical axis and intersecting the first direction. The lens barrel is disposed to at least partially expose the coupling member in the first direction and to at least partially overlap the coupling member in the second direction.

### CROSS-REFERENCE TO RELATED APPLICATIONS

This application claims the benefit under 35 USC 119(a) of Korean Patent Application No. 10-2021-0114943 filed on Aug. 30, 2021 in the Korean Intellectual Property Office, the entire disclosure of which is incorporated herein by reference for all purposes.

### BACKGROUND

### 1. Field

The following description relates to a camera, and more particularly, to a small-sized camera employed in a mobile device.

### 2. Description of Background

A camera module employed in mobile devices such as smartphones and tablets has been developed to have a reduced thickness. Also, to provide high magnification, a folded camera using an optical path changing member such as a prism or mirror has emerged. To implement a low F-number and high resolution in a folded camera, an aperture of a lens may need to have a certain level or more in size, and accordingly, a lens (e.g., a decut lens) in which a portion thereof is cut out may be employed.

A lens module including a lens barrel and a lens accommodated in the lens barrel may further include a coupling member such as a pressing ring for fixing the lens. The pressing ring may be disposed on one side of the lens and may fix the lens to the lens barrel. Generally, the pressing ring may be disposed in an inner circumferential surface of the lens barrel or disposed outside an outer circumferential surface. When the pressing ring is disposed in the lens barrel, a thickness of the lens barrel may increase due to the pressing ring, and when the pressing ring is disposed outside the lens barrel, a thickness of the entire lens assembly may increase by the pressing ring. It may be important to reduce a thickness of the lens barrel in mobile devices, it may be necessary to eliminate or minimize the increase in the thickness of the barrel caused by the pressing ring.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a lens module includes a lens barrel; a lens accommodated in the lens barrel; and a coupling member coupled to the lens barrel, disposed on one side of the lens and configured to fix the lens to the lens barrel. A width of the lens in a first direction perpendicular to an optical axis is smaller than a width of the lens in a second direction perpendicular to the optical axis and intersecting the first direction. The lens barrel is disposed to at least partially expose the coupling member in the first direction and to at least partially overlap the coupling member in the second direction.

A width of the coupling member in the first direction may be the same or substantially the same as a width of the lens barrel in the first direction.

The lens barrel may include a first recess at least partially defined by a surface recessed from an object-side end surface of the lens barrel toward an image-side, and the first recess may be configured to partially accommodate the coupling member.

The lens barrel may include a first side portion defining a width of the lens barrel in the first direction and a second side portion defining a width of the lens barrel in the second direction, the first side portion may include a first recess configured to at least partially expose the coupling member in the first direction, and the second side portion may overlap the coupling member in the second direction.

The coupling member may include a first portion defining a width of the coupling member in the first direction and a second portion defining a width of the coupling member in the second direction, the first portion may be at least partially exposed in the first direction, and the second portion may at least partially overlap the lens barrel in the second direction.

When the coupling member and the lens barrel are coupled to each other, the coupling member or the lens barrel may define a groove connecting to a coupling surface between the lens barrel and the coupling member.

The lens module may include an adhesive member disposed in the groove.

The lens may include linear portions opposing each other in the first direction and curved portions opposing each other in the second direction.

The coupling member may include first portions corresponding to the linear portions and second portions corresponding to the curved portions, each of the first portions of the coupling member may be in contact with the lens barrel in a direction parallel to the optical axis, and each of the second portions of the coupling member may be in contact with the lens barrel in a direction perpendicular to the optical axis.

The lens barrel may include first recesses at least partially defined by surfaces recessed from object-side end surfaces of the lens barrel toward an image-side, and each of the first recesses may accommodate at least a portion of one of the first portions of the coupling member.

Each of the second portions may include a second recess at least partially defined by a surface recessed from an object-side end surface of the respective second portion toward an image-side.

In another general aspect, a lens module includes a lens barrel; a lens accommodated in the lens barrel; and a coupling member coupled to the lens barrel, disposed on one side of the lens, and configured to fix the lens to the lens barrel. The coupling member includes a first portion in contact with the lens barrel in a direction parallel to an optical axis and a second portion in contact with the lens barrel in a direction perpendicular to the optical axis.

In another general aspect, a camera module includes an optical path changing member configured to change a traveling direction of light; a lens module disposed on one side of the optical path changing member and configured to move in an optical axis direction; and an image sensor.

Other features and aspects will be apparent from the following detailed description, the drawings, and the claims.

### BRIEF DESCRIPTION OF DRAWINGS

FIG. 1 is a perspective diagram illustrating a camera module according to an example.

FIG. 2 is a perspective diagram illustrating a lens module according to an example.

FIG. 3 is an exploded perspective diagram illustrating the lens module illustrated in FIG. 2.

FIG. 4 is a cross-sectional diagram taken along line I-I′ in FIG. 2.

FIG. 5 is a cross-sectional diagram taken along line II-II′ in FIG. 2.

FIG. 6 is a perspective diagram illustrating a lens module according to an example.

FIG. 7 is an exploded perspective diagram illustrating the lens module illustrated in FIG. 6.

FIG. 8 is a cross-sectional diagram taken along line III-III′ in FIG. 6.

FIG. 9 is a cross-sectional diagram taken along line IV-IV′ in FIG. 6.

Throughout the drawings and the detailed description, the same reference numerals refer to the same elements. The drawings may not be to scale, and the relative size, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The drawings may not be to scale, and the relative sizes, proportions, and depiction of elements in the drawings may be exaggerated for clarity, illustration, and convenience.

In the examples, the X-direction, the Y-direction, and the Z-direction may refer to a direction parallel to the X axis, a direction parallel to the Y axis, and a direction parallel to the Z axis, respectively, illustrated in the drawings. Also, the X-direction may include both the +X-axis direction and the −X-axis direction, which may also be applied to the Y-direction and the Z-direction, unless otherwise indicated.

In the examples, the notion that two directions (or axes) are parallel to or perpendicular to each other may also include the examples in which the two directions (or axes) are substantially parallel or substantially side by side with each other. For example, the notion that the first axis and the second axis are perpendicular to each other may indicate that the first axis and the second axis may form an angle of 90 degrees or an angle close to 90 degrees.

In the examples, “configured to” indicates that a component includes a structure necessary to implement a certain function.

The present disclosure is not limited to the specific examples, and it is to be understood that various modifications may be made without departing from the spirit and scope of the present disclosure.

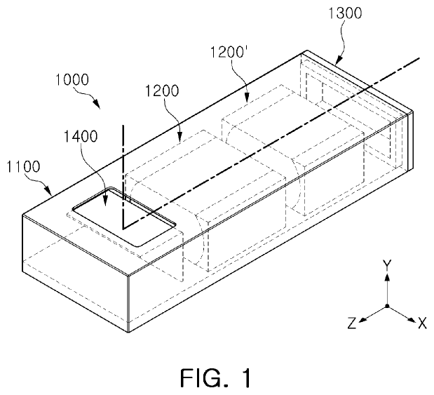

FIG. 1 is a perspective diagram illustrating a camera module 1000 according to an example.

The camera module 1000 may include a housing 1100, a lens module 1200 disposed in the housing 1100, and an image sensor module 1300. The lens module 1200 may include at least one lens, and light passing through the at least one lens may reach the image sensor of the image sensor module 1300.

In an example, the lens module 1200 may be disposed in the housing 1100 and configured to move in the optical axis direction. In an example, the camera module 1000 may include two or more lens modules. For example, the camera module 1000 may further include an additional lens module 1200′. A focal length may be adjusted depending on the movement of the two lens modules 1200 and 1200′. In an example, at least one of the two or more lens modules may be disposed in the housing 1100 and configured to move in the optical axis direction. As the two or more lens modules are independently driven in the optical axis direction, magnification may be adjusted.

In an example, the camera module 1000 may include an optical path changing member 1400 configured to change a traveling direction of light. The optical path changing member 1400 may be implemented by a prism or a mirror, for example. Light incident in the Y-axis direction toward the camera module 1000 may be folded by the optical path changing member 1400 and may be directed toward the lens module 1200. By the optical path changing member 1400, the camera module 1000 may have a reduced thickness and may provide a long total track length, thereby providing an image with a high magnification.

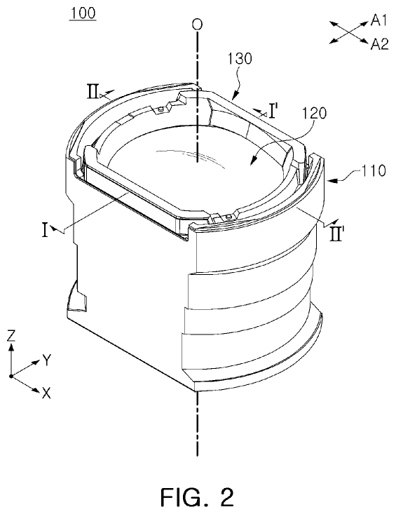

Hereinafter, examples of the lens modules 1200 and 1200′ will be described with reference to FIGS. 2 to 9. The lens modules 100 and 200 described with reference to FIGS. 2 to 11 may be applied to the camera module 1000 in FIG. 1.

In the description below, in describing the lens module or elements included in the lens module, the optical axis direction may refer to a traveling direction of light. The optical axis direction may include an object-side direction and an image-side direction, and the object-side direction may refer to a direction from the lens module toward a subject, and the image-side direction may refer to a direction from the lens module toward the image sensor. For example, the optical axis direction may be parallel to the Z axis, the object-side direction may refer to the +Z-direction, and the image-side direction may refer to the −Z-direction.

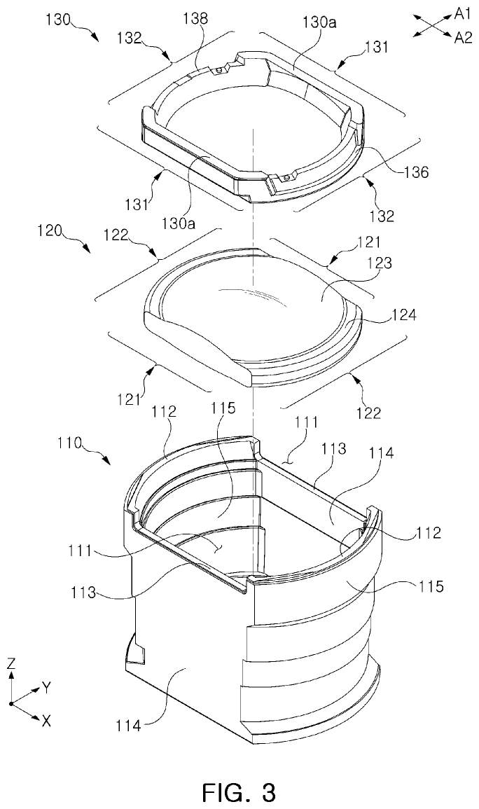

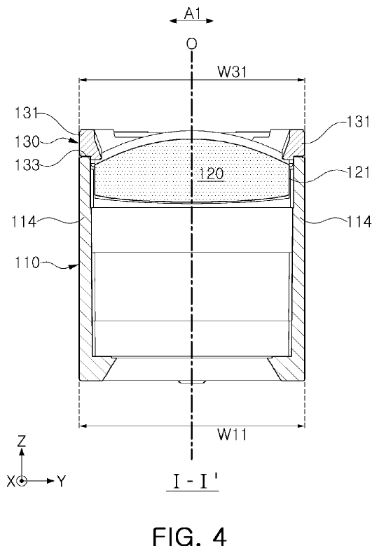

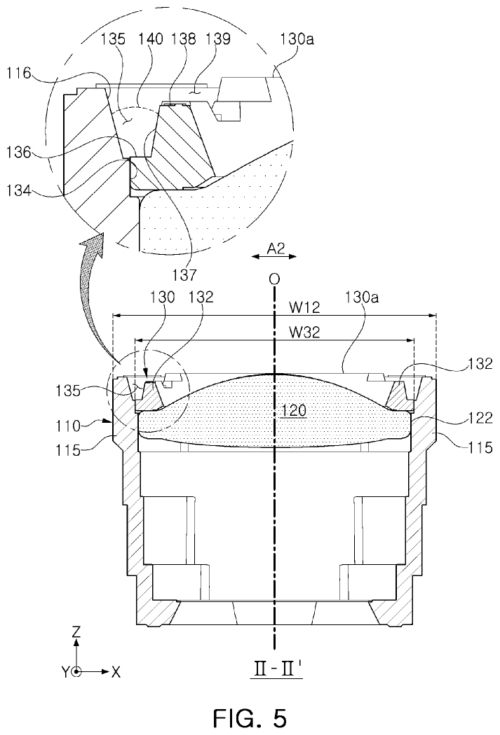

FIG. 2 is a perspective diagram illustrating a lens module 100 according to an example. FIG. 3 is an exploded perspective diagram illustrating the lens module 100 illustrated in FIG. 2. FIG. 4 is a cross-sectional diagram taken along line I-I′ in FIG. 2. FIG. 5 is a cross-sectional diagram taken along line II-II′ in FIG. 2. In the description below, the example embodiments will be described with reference to FIGS. 2 to 5.

In an example, the lens module 100 may include a lens barrel 110, a lens 120 disposed in the lens barrel 110, and a coupling member 130 configured to fix the lens 120 to the lens barrel 110. The lens module 100 may further include other elements in addition to the illustrated elements.

A single lens 120 may be disposed in the lens barrel 110 in FIGS. 3 to 5, but the configuration thereof is not limited thereto. Lenses other than the illustrated lens 120 may be disposed in the lens barrel 110.

The coupling member 130 may be provided in the form of a ring defining an incident hole corresponding to the optical axis O and extending along an edge of the lens 120. The coupling member 130 may be at least partially in contact with the lens 120 and may be fixed and coupled to the lens barrel 110, thereby fixing the lens 120 to the lens barrel 110.

In an example, the lens barrel 110 may be disposed to overlap a portion of the coupling member 130 in a direction perpendicular to the optical axis O, and may be configured to expose the other portion of the coupling member 130 in a direction perpendicular to the optical axis O. In the example, the configuration in which the coupling member 130 is exposed in a predetermined direction may indicate that the lens barrel 110 may be configured to not cover the coupling member 130 in the predetermined direction such that, when the lens module 100 is viewed in the predetermined direction, a portion of the coupling member 130 may be visible.

In an example, the lens barrel 110 may be configured to at least partially expose the coupling member 130 in a first direction A1 perpendicular to the optical axis O. In an example, the lens barrel 110 may overlap the coupling member 130 in a second direction A2 perpendicular to the optical axis O and intersecting the first direction. For example, referring to FIGS. 4 and 5, the coupling member 130 may partially overlap the lens barrel 110 in the X-direction, and may be partially exposed in the Y-direction.

In an example, the lens module 100 may be configured such that a width of the lens module 100 in the first direction A1 may be smaller than a width in the second direction A2 intersecting the first direction A1. For example, the width of the lens module 100 in the Y-direction may be smaller than the width in the X-direction. Accordingly, an overall thickness of the camera module 1000 may be reduced. Hereinafter, in the example, the first direction A1 may correspond to a relatively small width of the lens module 100, and may be referred to as a short-axis direction. The second direction A2 may correspond to a relatively large width of the lens module 100 and may be referred to as a long-axis direction. The short-axis direction A1 and the long-axis direction A2 may be used to define lengths of elements (e.g., the lens barrel 110, the lens 120, and the coupling member 130) included in the lens module 100.

Referring to FIGS. 2 and 4, in an example, the width W31 of the coupling member 130 in the short-axis direction A1 may be the same or substantially the same with the width W11 of the lens barrel 110 in the short-axis direction A1. Accordingly, the width of the lens module 100 in the short-axis direction A1 may not increase by the coupling member 130, and the thickness of the camera module 1000 may be reduced.

Referring to FIG. 3, in an example, the lens barrel 110 may include a first recess 111 configured to accommodate the coupling member 130. In an example, the lens barrel 110 may include a first recessed surface 113 recessed from an object-side end surface 112 toward an image-side. The first recessed surface 113 and a surface extending from both ends of the first recessed surface 113 to the object-side end surface 112 may define the first recess 111. A portion of the coupling member 130 may be disposed in the first recess 111 and may be exposed in the short-axis direction A1.

Referring to FIG. 3, in an example, the lens barrel 110 may include a first side portion 114 defining the width of the lens barrel 110 in the short-axis direction A1 and a second side portion 115 defining the width of the lens barrel 110 in the long-axis direction A2. The first side portion 114 of the lens barrel 110 may be disposed on both sides in the short-axis direction A1 with respect to the optical axis O, and the second side portion 115 of the coupling member 130 may be disposed on both sides in the long-axis direction A2 with respect to the optical axis O. The first side portion 114 may be disposed in the short-axis direction A1 of the lens 120, and the second side portion 115 may be disposed in the long-axis direction A2 of the lens 120.

In an example, the lens barrel 110 may be configured to at least partially expose the coupling member 130 in the short-axis direction A1. For example, the first side portion 114 may include the first recess 111, and the coupling member 130 may be exposed in the short-axis direction A1 through the first recess 111. In an example, the lens barrel 110 may be configured to overlap the coupling member 130 in the long-axis direction A2. For example, the second side portion 115 of the lens barrel 110 may be provided in a form surrounding an outer circumferential surface of the coupling member 130.

Referring to FIG. 3, the coupling member 130 may include a first portion 131 defining the width of the coupling member 130 in the short-axis direction A1, and a second portion 132 defining the width of the coupling member 130 in the long-axis direction A2. The first portion 131 of the coupling member 130 may be disposed on both sides in the short-axis direction A1 with respect to the optical axis O, and the second portion 132 of the coupling member 130 may be disposed on both sides in the long-axis direction A2 with respect to the optical axis O.

Referring to FIGS. 2, 4, and 5, the first portion 131 of the coupling member 130 may be at least partially exposed in the short-axis direction A1 through the first recess 111 of the lens barrel 110. The second portion 132 of the coupling member 130 may at least partially overlap in the long-axis direction A2 by the lens barrel 110, and may not be exposed in the long-axis direction A2.

Referring to FIG. 3, in an example, a width of the lens 120 in the first direction A1 perpendicular to the optical axis O may be configured to be smaller than a width in the second direction A2 intersecting the optical axis O and the first direction A1. For example, the width of the lens 120 in the Y-direction may be smaller than the width of the lens 120 in the X-direction. Hereinafter, the first direction A1 may be referred to as a short-axis direction, and the second direction A2 may be referred to as a long-axis direction.

In an example, the lens 120 may have a decut shape. For example, an edge of the lens 120 may include linear portions 121 opposing each other in the short-axis direction A1 and curved portions 122 opposing each other in the long-axis direction A2. The width of the lens 120 in the long-axis direction A2 may correspond to a distance between the two curved portions 122, and the width of the lens 120 in the short-axis direction A1 may correspond to a distance between the two linear portions 121.

In an example, the lens 120 may include an optical unit 123 exhibiting optical performance and a flange unit 124 extending outwardly from the optical unit 123. The flange portion 124 may not exhibit optical performance, and may be configured as a structure for the lens 120 to be fixed to the lens barrel 110. For example, referring to FIG. 5, a lower surface of the coupling member 130 may be in contact with the flange portion 124.

Referring to FIG. 3, in an example, the first portion 131 of the coupling member 130 may extend along the linear portion 121 of the lens 120, and the second portion 132 of the coupling member 130 may extend along the curved portion 122 of the lens 120. For example, the first portion 131 of the coupling member 130 may extend in the long-axis direction A2, and the second portion 132 may extend in a circumferential direction with respect to the optical axis O. Accordingly, the overall shape of the coupling member 130 may be provided in a decut form (or a track form) similarly to the lens 120.

In an example, the first side portion 114 of the lens barrel 110 may be provided in the form of a plane panel along the linear portion 121 of the lens 120, and the second side portion 115 may be provided in the form of a curved panel along the curved portion 122. Accordingly, the overall shape of the lens barrel 110 may be provided in a decut form (or a track form) similarly to the lens 120.

Referring to FIG. 4, an external side surface of the first portion 131 of the coupling member 130 may be the same or substantially the same with an external side surface of the lens barrel 110. Referring to FIG. 5, the second portion 132 of the coupling member 130 may be disposed on an inner side of the lens barrel 110. That is, the external side surface of the second portion 132 may be in contact with an internal side surface of the lens barrel 110. For example, the width W32 of the second portion 132 of the coupling member 130 in the long-axis direction A2 may be smaller than the width W12 of the second side portion 115 of the lens barrel 110 in the long-axis direction A2.

Referring to FIGS. 4 and 5, in an example, a portion of the coupling member 130 may be in contact with the lens barrel 110 in a direction parallel to or substantially parallel to the optical axis O. The other portion of the coupling member 130 may be in contact with the lens barrel 110 in a direction perpendicular to or substantially perpendicular to the optical axis O. In the example, the configuration in which the coupling member 130 and the lens barrel 110 are in contact with each other in a predetermined direction may indicate that a coupling surface (or contact surface) between the element may be directed in the predetermined direction. For example, the configuration in which the coupling member 130 and the lens barrel 110 are in contact with each other in the Z-direction may indicate that a normal line of the coupling surface between the coupling member 130 and the lens barrel 110 may be parallel to the Z-direction.

In an example, a portion (or the first portion 131) defining the width of the coupling member 130 in the short-axis direction A1 may be in contact with the lens barrel 110 in a direction parallel to or substantially parallel to the optical axis O. For example, referring to FIG. 4, a first coupling surface 133 between the lens barrel 110 and the coupling member 130 may be perpendicular to the Z axis. In the illustrated example, the first coupling surface 133 between the lens barrel 110 and the coupling member 130 may extend in the short-axis direction A1 (the Y-direction), but the configuration thereof is not limited thereto. In another example, the first coupling surface 133 may include an inclined surface. For example, referring to FIG. 4, the first coupling surface 133 may extend in a direction between the Z-direction and the Y-direction.

In an example, the portion (or the second portion 132) defining the width of the coupling member 130 in the long-axis direction A2 may be in contact with the lens barrel 110 in a direction perpendicular to or substantially perpendicular to the optical axis O. Referring to FIG. 5, a second coupling surface 134 between the lens barrel 110 and the coupling member 130 may be perpendicular to the X axis. In the illustrated example, the second coupling surface 134 between the lens barrel 110 and the coupling member 130 may extend in the optical axis O direction (the Z-direction), but a configuration thereof is not limited thereto. In another example, the second coupling surface 134 may include an inclined surface. For example, referring to FIG. 5, the second coupling surface 134 may extend in a direction between the X-direction and the Z-direction.

In an example, the coupling member 130 or the lens barrel 110 may be configured to define a groove 135 between the lens barrel 110 and the coupling member 130 when the coupling member 130 and the lens barrel 110 are coupled to each other. Referring to FIG. 5, the groove 135 may be formed between the coupling member 130 and the lens barrel 110. In an example, an adhesive member 140 may be disposed in the groove 135. The adhesive member 140 may be configured to fix the coupling member 130 to the lens barrel 110. The adhesive member 140 may fill the groove 135 in a liquid state, may be cured, and may fix the coupling member 130 to the lens barrel 110.

Referring to FIG. 5, in an example, the groove 135 may be connected to the second coupling surface 134 between the coupling member 130 and the lens barrel 110. A portion of the adhesive member 140 filled in the groove 135 may permeate to the second coupling surface 134 and may further strengthen the coupling between the coupling member 130 and the lens barrel 110.

In an example, the groove 135 may be formed between a portion (the second portion 132) defining a length of the coupling member 130 in the long-axis direction A2 and the lens barrel 110. Referring to FIG. 5, the second portion 132 may include a second recessed surface 136 recessed from an object-side end surface 130a of the coupling member 130 toward the image-side. The second recessed surface 136 may partially form a bottom surface of the groove 135.

The second portion 132 of the coupling member 130 and the lens barrel 110 may include inclined surfaces 116 and 137 partially defining the groove 135, respectively. For example, referring to FIG. 5, the second portion 132 of the coupling member 130 may include an inclined surface 137 extending from the second recessed surface 136 toward an object-side. The second side portion 115 of the lens barrel 110 may include an inclined surface 116 connected to the second coupling surface 134 with the coupling member 130 and extending toward the object-side.

In an example, the coupling member 130 may include a second recess 139 at least partially defined by a third recessed surface 138 recessed from the object-side end surface 130a to an image-side. The second recess 139 may be connected to the groove 135 and may provide a space in which a needle-shaped adhesive filling device for injecting the adhesive member 140 into the groove 135 may be disposed. In an example, the second recess 139 may be formed in a portion (the second portion 132) defining the length of the coupling member 130 in the long axis direction A2. Referring to FIG. 5, the second recessed surface 136 may be recessed upwardly from the third recessed surface 138.

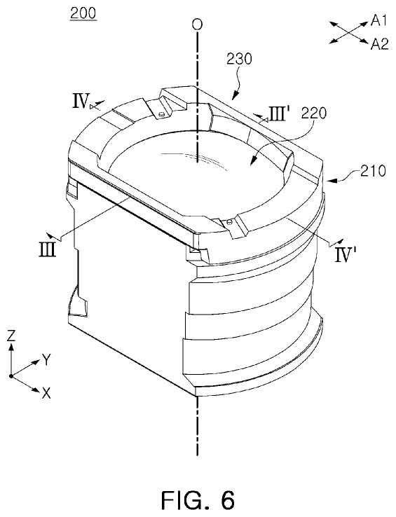

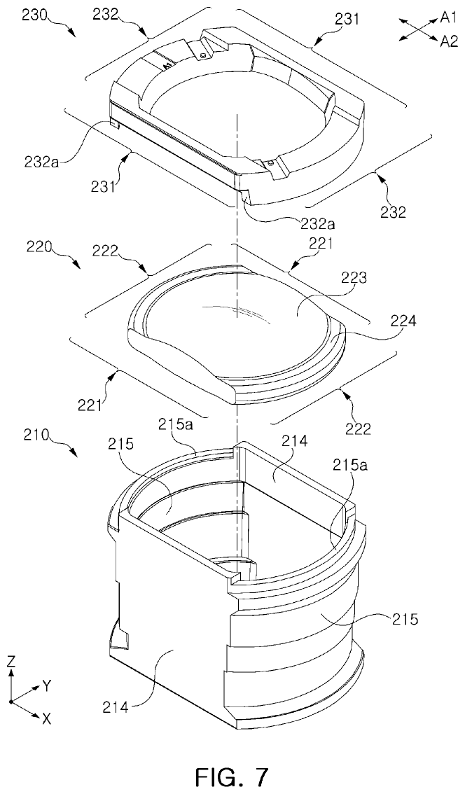

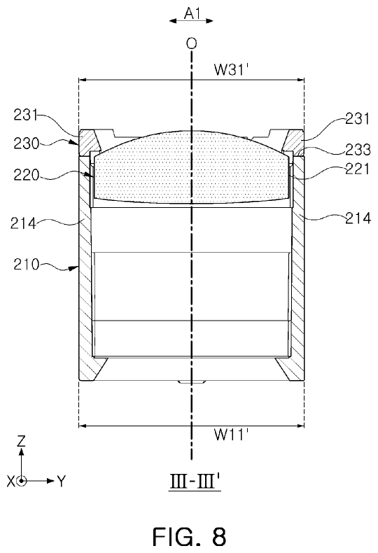

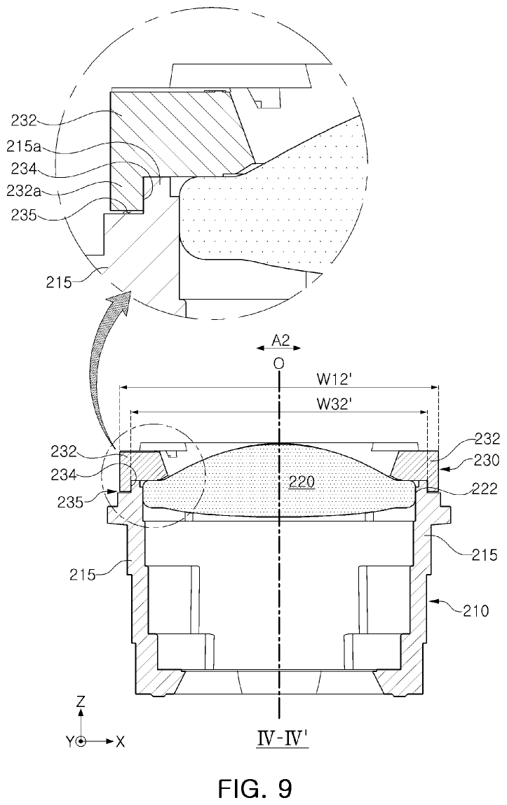

FIG. 6 is a perspective diagram illustrating a lens module 200 according to an example. FIG. 7 is an exploded perspective diagram illustrating the lens module 200 illustrated in FIG. 6. FIG. 8 is a cross-sectional diagram taken along line III-III′ in FIG. 6. FIG. 9 is a cross-sectional diagram taken along line IV-IV′ in FIG. 6. The example embodiments will be described with reference to FIGS. 6 to 9.

In an example, the lens module 200 may include a lens barrel 210, a lens 220 disposed in the lens barrel 210, and a coupling member 230 configured to fix the lens 220 to the lens barrel 210. The lens module 200 may further include elements other than the illustrated elements.

A single lens 220 may be disposed in the lens barrel 210 in FIGS. 7 to 9, but the configuration thereof is not limited thereto. Lenses other than the illustrated lens 220 may be disposed in the lens barrel 210.

The coupling member 230 may be provided in the form of a ring defining an incident hole corresponding to the optical axis O, and extending along an edge of the lens 220. The coupling member 230 may at least partially be in contact with the lens 220 and may be fixed and coupled to the lens barrel 210, thereby fixing the lens 220 to the lens barrel 210.

In an example, the lens barrel 210 may be disposed to overlap a portion of the coupling member 230 in a direction perpendicular to the optical axis O, and may be configured to expose the other portion of the coupling member 230 in a direction perpendicular to the optical axis O. In the example, the configuration in which the coupling member 230 is exposed in a predetermined direction may indicate that the lens barrel 210 may be configured to not cover the coupling member 230 in the predetermined direction such that, when the lens module 200 is viewed in the predetermined direction, a portion of the coupling member 230 may be visible.

In an example, the lens barrel 210 may be configured to at least partially expose the coupling member 230 in a first direction A1 perpendicular to the optical axis O. In an example, the lens barrel 210 may overlap the coupling member 230 in a second direction A2 perpendicular to the optical axis O and intersecting the first direction. For example, referring to FIGS. 8 and 9, the coupling member 230 may partially overlap the lens barrel 210 in the X-direction, and may be partially exposed in the Y-direction.

In an example, the lens module 200 may be configured such that the width of the lens module 200 in the first direction A1 may be smaller than the width in the second direction A2 intersecting the first direction A1. For example, the width of the lens module 200 in the Y-direction may be smaller than the width in the X-direction. Accordingly, the overall thickness of the lens module 200 may be reduced. Hereinafter, in the example, the first direction A1 may correspond to a relatively small width of the lens module 200, and may be referred to as a short-axis direction. The second direction A2 may correspond to a relatively large width of the lens module 200 and may be referred to as a long-axis direction. The short-axis direction A1 and the long-axis direction A2 may be used to define lengths of elements (e.g., the lens barrel 210, the lens 220, and the coupling member 230) included in the lens module 200.

Referring to FIGS. 6 and 8, in an example, a width W31′ of the coupling member 230 in the short-axis direction A1 may be the same or substantially the same with a width W11′ of the lens barrel 210 in the short-axis direction A1. Accordingly, the width of the lens module 200 in the short-axis direction A1 may not increase by the coupling member 230, and the thickness of the camera module 200 may be reduced.

Referring to FIG. 6, in an example, the lens barrel 210 may include a first side portion 214 defining the width of the lens barrel 210 in the short-axis direction A1 and a second side portion 215 defining the width of the lens barrel 210 in the long-axis direction A2. The first side portion 214 of the lens barrel 210 may be disposed on both sides in the short-axis direction A1 with respect to the optical axis O, and the second side portion 215 of the coupling member 230 may be disposed on both sides in the long-axis direction A2 with respect to the optical axis O. The first side portion 214 may be disposed in the short-axis direction A1 of the lens 220, and the second side portion 215 may be disposed in the long-axis direction A2 of the lens 220.

In an example, the lens barrel 210 may be configured to at least partially expose the coupling member 230 in the short-axis direction A1. In an example, the lens barrel 210 may be configured to overlap the coupling member 230 in the long-axis direction A2. For example, the coupling member 230 may be provided to partially enclose the second side portion 215 of the lens barrel 210.

Referring to FIG. 6, in an example, the coupling member 230 may include a first portion 231 defining the width of the coupling member 230 in the short-axis direction A1, and a second portion 232 defining the width of the coupling member 230 in the long-axis direction A2. The first portion 231 of the coupling member 230 may be disposed on both sides in the short-axis direction A1 with respect to the optical axis O, and the second portion 232 of the coupling member 230 may be disposed on both sides in the long-axis direction A2 with respect to the optical axis O.

Referring to FIGS. 6, 8, and 9, the first portion 231 of the coupling member 230 may be exposed in the short-axis direction A1 of the lens barrel 210. The second portion 232 of the coupling member 230 may at least partially overlap the lens barrel 210 in the long-axis direction A2, and a portion of the lens barrel 210 may not be exposed in the long-axis direction A2.

Referring to FIG. 7, in an example, a width of the lens 220 in the first direction A1 perpendicular to the optical axis O may be configured to be smaller than a width in the second direction A2 intersecting the optical axis O and the first direction A1. For example, the width of the lens 220 in the Y-direction may be smaller than the width of the lens 220 in the X-direction. Hereinafter, the first direction A1 may be referred to as a short-axis direction, and the second direction A2 may be referred to as a long-axis direction.

In an example, the lens 220 may have a decut shape. For example, an edge of the lens 220 may include linear portions 221 opposing each other in the short-axis direction A1 and curved portions 222 opposing each other in the long-axis direction A2. The width of the lens 220 in the long-axis direction A2 may correspond to a distance between the two curved portions 222, and the width of the lens 220 in the short-axis direction A1 may correspond to a distance between the two linear portions 221.

In an example, the lens 220 may include an optical unit 223 exhibiting optical performance and a flange unit 224 extending outwardly from the optical unit 223. The flange portion 224 may not exhibit optical performance, and may be configured as a structure for the lens 220 to be fixed to the lens barrel 210. For example, referring to FIG. 9, a lower surface of the coupling member 230 may be in contact with the flange portion 224.

Referring to FIG. 7, in an example, the first portion 231 of the coupling member 230 may extend along the linear portion 221 of the lens 220, and the second portion 232 of the coupling member 230 may extend along the curved portion 222 of the lens 220. For example, the first portion 231 of the coupling member 230 may extend in the long-axis direction A2, and the second portion 232 may extend in a circumferential direction with respect to the optical axis O. Accordingly, the overall shape of the coupling member 230 may be provided in a decut form (or a track form) similarly to the lens 220.

In an example, the first side portion 214 of the lens barrel 210 may be provided in the form of a plane panel along the linear portion 221 of the lens 220, and the second side portion 215 may be provided in the form of a curved panel along the curved portion 222. Accordingly, the overall shape of the lens barrel 210 may be provided in a decut form (or a track form) similarly to the lens 220.

Referring to FIG. 8, an external side surface of the first portion 231 of the coupling member 230 may be the same or substantially the same with an external side surface of the lens barrel 210. Referring to FIG. 9, the second portion 232 of the coupling member 230 may include a first extension portion 232a extending to the image-side, and the extension portion 232a may enclose an outer circumferential surface of the lens barrel 210 in a circumferential direction. Also, the second side portion 215 of the lens barrel 210 may include a second extension portion 215a extending toward the object-side, and the second extension portion 215a may be in contact with an internal side surface of the coupling member 230. For example, the width W32′ of the second portion 232 of the coupling member 230 in the long-axis direction A2 may be greater than the width W12′ of the second extension portion 215a of the second side portion 215 of the lens barrel 210 in the long-axis direction A2.

Referring to FIGS. 7 and 8, in an example, a portion of the coupling member 230 may be in contact with the lens barrel 210 in a direction parallel to or substantially parallel to the optical axis O. The other portion of the coupling member 230 may be in contact with the lens barrel 210 in a direction perpendicular to or substantially perpendicular to the optical axis O. In the example, the configuration in which the coupling member 230 and the lens barrel 210 are in contact with each other in a predetermined direction may indicate that a coupling surface (or contact surface) between the element may be directed in the predetermined direction. For example, the configuration in which the coupling member 230 and the lens barrel 210 are in contact with each other in the Z-direction may indicate that a normal line of the coupling surface between the coupling member 230 and the lens barrel 210 may be parallel to the Z-direction.

In an example, the portion (or the first portion 231) defining the width of the coupling member 230 in the short-axis direction A1 may be in contact with the lens barrel 210 in a direction parallel to or substantially parallel to the optical axis O. For example, referring to FIG. 8, a first coupling surface 233 between the lens barrel 210 and the coupling member 230 may be perpendicular to the Z axis. In the illustrated example, the first coupling surface 233 between the lens barrel 210 and the coupling member 230 may extend in the short-axis direction A1 (the Y-direction), but the configuration thereof is not limited thereto. In another example, the first coupling surface 233 may include an inclined surface. For example, referring to FIG. 8, the first coupling surface 233 may extend in a direction between the Z-direction and the Y-direction.

In an example, the portion (or the second portion 232) defining the width of the coupling member 230 in the long-axis direction A2 may be in contact with the lens barrel 210 in a direction perpendicular to or substantially perpendicular to the optical axis O. Referring to FIG. 9, a second coupling surface 234 between the lens barrel 210 and the coupling member 230 may be perpendicular to the X axis. In the illustrated example, the second coupling surface 234 between the lens barrel 210 and the coupling member 230 may extend in the optical axis O direction (the Z-direction), but the configuration thereof is not limited thereto. In another example, the second coupling surface 234 may include an inclined surface. For example, referring to FIG. 5, the second coupling surface 234 may extend in a direction between the X-direction and the Z-direction.

In an example, the coupling member 230 or the lens barrel 210 may be configured to define a groove 235 between the lens barrel 210 and the coupling member 230 when the coupling member 230 and the lens barrel 210 are coupled to each other. Referring to FIG. 9, the groove 235 may be formed between the coupling member 230 and the lens barrel 210. In an example, an adhesive member may be disposed in the groove 235. The adhesive member may be configured to fix the coupling member 230 to the lens barrel 210. The adhesive member may fill the groove 235 in a liquid state, may be cured, and may fix the coupling member 230 to the lens barrel 210.

Referring to FIG. 9, in an example, the groove 235 may be connected to the second coupling surface 234 between the coupling member 230 and the lens barrel 210. A portion of the adhesive member filled in the groove 235 may permeate to the second coupling surface 234 and may further strengthen the coupling between the coupling member 230 and the lens barrel 210.

In an example, the groove 235 may be formed between a portion (the second portion 232) defining the length of the coupling member 230 in the long-axis direction A2 and the lens barrel 210.

According to the aforementioned examples, a camera module having a reduced thickness and high performance may be provided.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens module, comprising:
a lens barrel;
a lens accommodated in the lens barrel; and
a coupling member coupled to the lens barrel, disposed on one side of the lens and configured to fix the lens to the lens barrel,
wherein a width of the lens in a first direction perpendicular to an optical axis is smaller than a width of the lens in a second direction perpendicular to the optical axis and intersecting the first direction, and
wherein the lens barrel is disposed to at least partially expose the coupling member in the first direction and to at least partially overlap the coupling member in the second direction.

2. The lens module of claim 1, wherein a width of the coupling member in the first direction is the same or substantially the same as a width of the lens barrel in the first direction.

3. The lens module of claim 1, wherein the lens barrel comprises a first recess at least partially defined by a surface recessed from an object-side end surface of the lens barrel toward an image-side, and the first recess is configured to partially accommodate the coupling member.

4. The lens module of claim 1,
wherein the lens barrel comprises a first side portion defining a width of the lens barrel in the first direction and a second side portion defining a width of the lens barrel in the second direction, and
wherein the first side portion includes a first recess configured to at least partially expose the coupling member in the first direction, and the second side portion overlaps the coupling member in the second direction.

5. The lens module of claim 1,
wherein the coupling member comprises a first portion defining a width of the coupling member in the first direction and a second portion defining a width of the coupling member in the second direction, and
wherein the first portion is at least partially exposed in the first direction, and the second portion at least partially overlaps the lens barrel in the second direction.

6. The lens module of claim 1, wherein, when the coupling member and the lens barrel are coupled to each other, the coupling member or the lens barrel is configured to define a groove connecting to a coupling surface between the lens barrel and the coupling member.

7. The lens module of claim 6, further comprising:
an adhesive member disposed in the groove.

8. The lens module of claim 1, wherein the lens comprises linear portions opposing each other in the first direction and curved portions opposing each other in the second direction.

9. The lens module of claim 8,
wherein the coupling member comprises first portions corresponding to the linear portions and second portions corresponding to the curved portions, and
wherein each of the first portions of the coupling member is in contact with the lens barrel in a direction parallel to the optical axis, and each of the second portions of the coupling member is in contact with the lens barrel in a direction perpendicular to the optical axis.

10. The lens module of claim 9, wherein the lens barrel comprises first recesses at least partially defined by surfaces recessed from object-side end surfaces of the lens barrel toward an image-side, and each of the first recesses is configured to accommodate at least a portion of one of the first portions of the coupling member.

11. The lens module of claim 9, wherein each of the second portions includes a second recess at least partially defined by a surface recessed from an object-side end surface of the respective second portion toward an image-side.

12. A lens module, comprising:
a lens barrel;
a lens accommodated in the lens barrel; and
a coupling member coupled to the lens barrel, disposed on one side of the lens, and configured to fix the lens to the lens barrel,
wherein the coupling member comprises a first portion in contact with the lens barrel in a direction parallel to an optical axis and a second portion in contact with the lens barrel in a direction perpendicular to the optical axis.

13. The lens module of claim 12,
wherein a width of the lens in a first direction perpendicular to the optical axis is smaller than a width of the lens in a second direction perpendicular to the optical axis and intersecting the first direction,
wherein the lens comprises linear portions opposing each other in the first direction and curved portions opposing each other in the second direction, and
wherein the first portion extends along at least one of the linear portions and the second portion extends along at least one of the curved portions.

14. The lens module of claim 13, wherein a width of the coupling member in the second direction is the same or substantially the same as a width of the lens barrel in the second direction.

15. The lens module of claim 12, wherein the lens barrel comprises a first recess at least partially defined by a surface recessed from an object-side end surface of the lens barrel toward an image-side, and the first recess is configured to accommodate at least a portion of the first portion of the coupling member.

16. A camera module, comprising:
an optical path changing member configured to change a traveling direction of light;
a lens module disposed on one side of the optical path changing member and configured to move in an optical axis direction; and
an image sensor.

17. The camera module of claim 16, wherein the lens module comprises:
a lens barrel;
a lens accommodated in the lens barrel; and
a coupling member coupled to the lens barrel, disposed on one side of the lens and configured to fix the lens to the lens barrel,
wherein a width of the lens in a first direction perpendicular to an optical axis is smaller than a width of the lens in a second direction perpendicular to the optical axis and intersecting the first direction, and
wherein the lens barrel is disposed to at least partially expose the coupling member in the first direction and to at least partially overlap the coupling member in the second direction.

18. The camera module of claim 16, wherein the lens module comprises:
a lens barrel;
a lens accommodated in the lens barrel; and
a coupling member coupled to the lens barrel, disposed on one side of the lens, and configured to fix the lens to the lens barrel,
wherein the coupling member comprises a first portion in contact with the lens barrel in a direction parallel to an optical axis and a second portion in contact with the lens barrel in a direction perpendicular to the optical axis.
